(19) United States
(12) Patent Application Publication
(10) Pub. No.: US 2013/0200695 A1
(43) Pub. Date: Aug. 8, 2013

(54) CONVERTER APPARATUS FOR A MOTOR VEHICLE COMPRISING A HIGH-VOLTAGE SYSTEM AND OPERATING METHOD FOR A HIGH-VOLTAGE SYSTEM COMPRISING A CORRESPONDING CONVERTER APPARATUS

(71) Applicant: Dr. Ing. h.c.F. Porsche Aktiengesellschaft, Stuttgart (DE)

(72) Inventor: Thomas Fritz, Loechgau (DE)

(73) Assignee: DR. ING. H.C.F. PORSCHE AKTIENGESELLSCHAFT, Stuttgart (DE)

(21) Appl. No.: 13/747,953

(22) Filed: Jan. 23, 2013

(30) Foreign Application Priority Data
Feb. 8, 2012 (DE) 10 2012 101 011.0

(51) Int. Cl. G05F 3/08; B60R 16/02

(52) U.S. Cl. CPC G05F 3/08; B60R 16/02
USPC 307/10.1; 323/304

(57) ABSTRACT

A converter apparatus (20) for a motor vehicle has a high-voltage system (5) comprising: a first input device (21), which is coupled to a first voltage domain (15) of the high-voltage system (5), a second input device (22), which is coupled to a second voltage domain (16) of the high-voltage system (5), and a DC/DC converter (28), which is coupled to the first input device (21) and the second input device (22) and which is designed to transfer electrical power from the first voltage domain (15) and the second voltage domain (16) to an output device (25) of the converter apparatus (20).

### CROSS REFERENCE TO RELATED APPLICATION

This application claims priority under 35 USC 119 to German Patent Appl. No. 10 2012 101 011.0 filed on Feb. 8, 2012, the entire disclosure of which is incorporated herein by reference.

### BACKGROUND OF THE INVENTION

1. Field of the Invention

The invention relates to a converter apparatus for a motor vehicle comprising a high-voltage system, and to an operating method for a high-voltage system comprising a corresponding converter apparatus.

2. Description of the Related Art

US 2009/0167077 describes a power supply device that can be mounted on or in a motor vehicle. The power supply device of US 2009/0167077 has a battery module, a power storage casing for accommodating the battery module, and a DC/DC converter module. The power supply device of US 2009/0167077 can provide three or more voltage values as electrical supply voltages.

US 2008/0072859 describes a battery apparatus with a plurality of battery modules, each of which has a multiplicity of series-connected battery cells. The battery apparatus of US 2008/0072859 also has voltage equalization circuits assigned respectively to the battery modules and configured to equalize voltages of the cells in each of the battery modules. Furthermore, the battery apparatus described in US 2008/0072859 has a connection switchover structure configured to switch a connection state of the battery modules between a series connection and a parallel connection. The battery apparatus described in US 2008/0072859 further has a voltage equalization control module configured, upon satisfaction of a predetermined voltage equalization condition, to control the voltage equalization circuits to equalize voltages of the respective cells in each of the battery modules in the state of a series connection of the battery modules. The voltage equalization control module also is configured to control the connection switchover structure, upon a satisfaction of a predetermined voltage equalization condition. Furthermore, the voltage equalization control module is configured, to control the connection switchover structure and the plurality of voltage equalization circuits to connect the battery modules in parallel and to equalize voltages of the respective battery modules upon completion of the voltage equalization of the respective cells in each of the battery modules.

US 2007/0202792 discloses a power source for motor vehicles comprising a battery housing, chargeable battery cells and air ducts for cooling the battery cells. The power source described therein has a multiplicity of air inlet and air outlet openings. The air inlet and air outlet openings are formed in a direction that deviates from the direction of the air ducts.

US 2007/0046259 describes a battery array that is cooled by air cooling with three or more levels. The battery array comprises two opposite side walls that form a closed chamber for the battery array.

DE 10 2009 035 468 A1 discloses an apparatus for storing and/or generating electrical energy. The apparatus described therein has at least two modules that are electrically coupled to one another. The two modules have different functionalities. More particularly, a first module is an electrochemical module. The electrochemical module is an electrical energy storage module designed for a high power and energy density. The second module is a traction module designed for a high power density.

The above-mentioned solutions are configured so that if two or more modules are provided for generating a nominal voltage of a high-voltage battery, an increase in the capacity of the high-voltage battery always necessitates two or more modules or multiples thereof to achieve an increase in the capacity of the high-voltage battery with the required nominal output voltage.

Therefore, it is an object of the invention to provide an improved converter apparatus for a motor vehicle comprising a high-voltage system.

### SUMMARY OF THE INVENTION

The invention relates to a converter apparatus for a motor vehicle comprising a high-voltage system and by an operating method for a high-voltage system.

A converter apparatus for a motor vehicle in accordance with the invention comprises a high-voltage system with a first input device coupled to a first voltage domain of the high-voltage system, a second input device coupled to a second voltage domain of the high-voltage system, and a DC/DC converter coupled to the first input device and the second input device and designed to transfer electrical power from the first voltage domain and the second voltage domain to an output device of the converter apparatus.

The present invention also provides an operating method for a high-voltage system comprising a corresponding converter apparatus. The method includes coupling the first input device of the converter apparatus to the first voltage domain of the high-voltage system, coupling the second input device of the converter apparatus to the second voltage domain of the high-voltage system, and transferring electrical power from the first voltage domain and from the second voltage domain to an output device of the converter apparatus using a DC/DC converter.

The method may include using a DC/DC converter supplied with a first nominal voltage of a first voltage domain and a second nominal voltage of a second voltage domain deviating from the first nominal voltage, wherein the abbreviation DC denotes a “direct current”.

The converter apparatus according to the invention makes it possible to provide a high-voltage battery having an odd number of battery cell modules, and thus makes it possible to provide a high-voltage battery comprising three battery cell modules.

The converter apparatus advantageously allows separate control of the first and second voltage domains of the high-voltage battery. Furthermore, an improvement in the aging behavior of battery cells used in the high-voltage system or the high-voltage battery is made possible.

The converter apparatus of the invention allows an adapted and stepwise increase in the range of the motor vehicle in small steps, since an even or odd number of battery cell modules or even half battery cell modules can be added expediently.

A first nominal voltage value of the first voltage domain may be provided to amount to an integral or rational-numbered multiple of a second nominal voltage value of the second voltage domain. The DC/DC converter thus can be operated with the first nominal voltage of, for example, 390 V from two battery cell modules, and with half that voltage, namely the second nominal voltage of 195 V from one battery cell module.

The first voltage domain may have a first number of battery cell modules and the second voltage domain may have a second number of battery cell modules. The conversion of the resulting different nominal voltages of the two voltage domains makes it possible for a high-voltage system to be constructed with an odd number of battery cell modules.

The first number of battery cell modules may be provided to amount to an integral or rational-numbered multiple of the second number of battery cell modules. The battery cell modules can thereby be interconnected differently within the two voltage domains.

The DC/DC converter preferably has a sensor for detecting the nominal voltage values of the first voltage domain and the second voltage domain. This brings about a secure supply of the high-voltage system of the motor vehicle.

The battery cell modules of the first voltage domain and/or of the second voltage domain may be connected in series. Thus, an increased nominal voltage can be achieved in comparison with the nominal voltage of the first voltage domain and/or of the second voltage domain at the output device and thus for the high-voltage system.

The battery cell modules of the first voltage domain and/or of the second voltage domain preferably are connected in parallel.

The DC/DC converter may be designed to provide an integral or rational-numbered multiple of the nominal voltage value of the first voltage domain and/or of the second voltage domain as a nominal voltage value of the output device.

An integral or rational-numbered multiple of a second nominal voltage value of the second voltage domain preferably is used as a first nominal voltage value of the first voltage domain.

The configurations and developments described can be combined, if expedient, arbitrarily with one another.

Further possible configurations, developments and implementations of the invention also encompass combinations—not explicitly mentioned—of features of the invention described above or below with regard to the exemplary embodiments.

The accompanying drawings are intended to convey a further understanding of the embodiments of the invention. They illustrate embodiments and serve in connection with the description to clarify principles and concepts of the invention.

Other embodiments and many of the advantages mentioned are evident in view of the drawings. The illustrated elements in the drawings are not necessarily shown in a manner true to scale with respect to one another.

### BRIEF DESCRIPTION OF THE DRAWINGS

FIG. 1 shows a schematic illustration of a converter apparatus according to the invention for a motor vehicle comprising a high-voltage system.

FIG. 2 shows a flow chart of an operating method according to the invention for a high-voltage system comprising a converter apparatus.

### DETAILED DESCRIPTION OF THE PREFERRED EMBODIMENTS

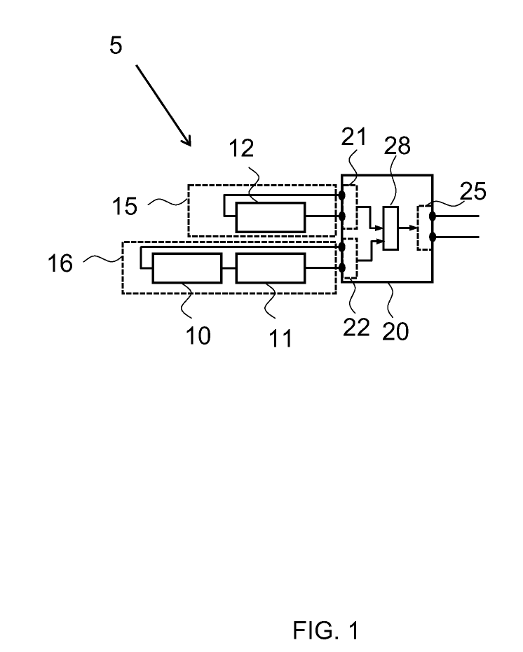

FIG. 1 is a schematic illustration of a converter apparatus according to the invention for a motor vehicle comprising a high-voltage system.

A voltage domain, as used herein, denotes a voltage region. The expression voltage domain can likewise be taken to mean a specific partial region of an electrical system or of a high-voltage system, a specific voltage region of the electrical system or of the high-voltage system prevailing within the specific partial region.

High-voltage systems for motor vehicles have electrical energy stores or high-voltage batteries. A modularization of the electrical energy store or of the high-voltage battery into individual battery cell modules can be provided.

A battery cell module of the electrical energy store preferably comprises plural battery cells electrically connected in series in a common unit, and preferably is a mechanical assemblage in the form of a battery cell module.

The battery cell preferably is an individual galvanic cell that supplies a characteristic voltage depending on the combination of the materials of the electrodes of the galvanic cell.

A converter apparatus 20 for a motor vehicle comprising a high-voltage system 5 has a first input device 21, a second input device 22, a DC/DC converter 28 and an output device 25.

The first input device 21 is coupled to a first voltage domain 15 of the high-voltage system 5. The first voltage domain 15 is defined for example by a nominal voltage of a battery cell module connected to the converter apparatus 20.

The second input device 22 is coupled to a second voltage domain 16 of the high-voltage system 5. The second voltage domain 16 is defined for example by a nominal voltage of a further battery cell module connected to the converter apparatus 20.

The DC/DC converter 28 is coupled to the first input device 21, the second input device 22 and the output device 25.

The DC/DC converter 28 is designed, for example, to transfer electrical power from the first voltage domain 15 and the second voltage domain 16 to the output device 25 of the converter apparatus 20.

The DC/DC converter 28 can be designed for a parallel connection of the first voltage domain 15 and the second voltage domain 16.

Furthermore, the DC/DC converter 28 can couple the first voltage domain 15 and the second voltage domain 16 by a series connection.

A first nominal voltage value of the first voltage domain 15 may be provided such that it amounts to an integral or rational-numbered multiple of a second nominal voltage value of the second voltage domain 16.

The first voltage domain 15 can have one battery cell module 12, for example, and the second voltage domain 16 can have two battery cell modules 10, 11.

The output device 25 is connected for example to an on-board electrical system of the motor vehicle. In this case, the on-board electrical system of the motor vehicle can be supplied with electrical energy via the converter apparatus 20 in order to supply electrical loads of the motor vehicle with electrical energy.

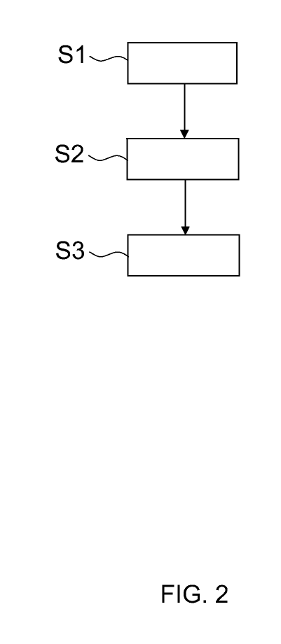

FIG. 2 shows a flow chart of an embodiment of the operating method according to the invention for a high-voltage system comprising a converter apparatus.

The operating method for a high-voltage system comprising the converter apparatus 20 comprises the following method steps: coupling S1 the first input device 21 of the converter apparatus 20 to the first voltage domain 15 of the high-voltage system 5; coupling S2 the second input device 22 of the converter apparatus 20 to the second voltage domain 16 of the high-voltage system 5; and transferring S3 electrical power from the first voltage domain 15 and from the second voltage domain 16 to an output device 25 of the converter apparatus 2 using a DC/DC converter 28.

It should be mentioned that the method steps shown in FIG. 2 can be repeated in any desired manner, for example recursively or iteratively.

Although the present invention has been completely described above on the basis of preferred exemplary embodiments, it is not restricted thereto, but rather can be modified in diverse ways.

What is claimed is:

1. A converter apparatus for a motor vehicle comprising a high-voltage system (5) comprising:
a first input device coupled to a first voltage domain of the high-voltage system;
a second input device coupled to a second voltage domain of the high-voltage system; and
a DC/DC converter coupled to the first input device and the second input device and designed to transfer electrical power from the first voltage domain and the second voltage domain to an output device of the converter apparatus.

2. The converter apparatus of claim 1, wherein a first nominal voltage value of the first voltage domain is provided to amount to an integral or rational-numbered multiple of a second nominal voltage value of the second voltage domain.

3. The converter apparatus of claim 1, wherein the first voltage domain has a first number of battery cell modules and the second voltage domain has a second number of battery cell modules.

4. The converter apparatus of claim 3, wherein the first number of battery cell modules is an integral or rational-numbered multiple of the second number of battery cell modules.

5. The converter apparatus of claim 1, wherein the DC/DC converter has a sensor for detecting the nominal voltage values of the first voltage domain and of the second voltage domain.

6. The converter apparatus of claim 1, wherein the battery cell modules of the first voltage domain and of the second voltage domain are connected in series.

7. The converter apparatus of claim 1, wherein the battery cell modules of the first voltage domain and of the second voltage domain are connected in parallel.

8. The converter apparatus of claim 1, wherein the DC/DC converter is designed to provide an integral or rational-numbered multiple of the nominal voltage value of the first voltage domain and the second voltage domain as a nominal voltage value of the output device.

9. An operating method for a high-voltage system comprising a converter apparatus, comprising:
coupling a first input device of the converter apparatus to a first voltage domain of the high-voltage system;
coupling a second input device of the converter apparatus to a second voltage domain of the high-voltage system; and
transferring electrical power from the first voltage domain and from the second voltage domain to an output device of the converter apparatus using a DC/DC converter.

10. The method of claim 9, wherein an integral or rational-numbered multiple of a second nominal voltage value of the second voltage domain is used as a first nominal voltage value of the first voltage domain.
